(19) United States
(12) Patent Application Publication
(10) Pub. No.: US 2025/0133314 A1
(43) Pub. Date: Apr. 24, 2025

(54) SYSTEMS AND METHODS FOR HYBRID TFDM CPON

(71) Applicant: CABLE TELEVISION LABORATORIES, INC., Louisville, CO (US)

(72) Inventors: ZHENSHENG JIA, Superior, CO (US); HAIPENG ZHANG, Broomfield, CO (US)

(21) Appl. No.: 18/925,890

(22) Filed: Oct. 24, 2024

Related U.S. Application Data
(60) Provisional application No. 63/545,460, filed on Oct. 24, 2023.

(51) Int. Cl. H04Q 11/00

(52) U.S. Cl. CPC H04Q 11/0067; H04Q 2011/0064; H04Q 2011/0086; H04Q 2213/13242; H04Q 2213/294

(57) ABSTRACT

A CPON includes an OLT for transmitting a downstream signal to a plurality of remote ONUs. The downstream signal includes a first data subcarrier and a second subcarrier adjacent the first subcarrier, and a first communication subcarrier between the first and second subcarriers. The CPON further includes a first ONU having a first ONU receiver for receiving the first data subcarrier from the downstream optical signal within a first channel bandwidth, and a first ONU transmitter for transmitting a first upstream signal to the OLT within the first channel bandwidth. The CPON further includes a second ONU having a second ONU receiver for receiving the second data subcarrier from the downstream optical signal within a second channel bandwidth, and a second ONU transmitter for transmitting a second upstream signal to the OLT within the second channel bandwidth. The first communication subcarrier includes OAM management data and/or MAC layer control information.

### CROSS REFERENCE TO RELATED APPLICATIONS

This application claims the benefit of and priority to U.S. Provisional Patent Application Ser. No. 63/545,460, filed Oct. 24, 2023, which is incorporated herein by reference in its entirety.

### BACKGROUND

The field of the disclosure relates generally to communication networks, and more particularly, coherent optical networks configured for hybrid time-and-frequency-division multiplexing (TFDM) transmission.

Conventional passive optical networks (PONs) are known to use point-to-multipoint (P2MP) architectures that are implemented extensively worldwide, and which have become a primary vehicle to meet the growing capacity demands in optical access networks. PON technology and architectures are expected to grow significantly in the near future, due to such factors as (a) increasing demand for high-speed internet, (b) need for more efficient and reliable network infrastructures, and (c) increasing adoption of fiber-to-the-home (FTTH) and fiber-to-the-premises (FTTP) technologies that rely on PONs to deliver high-speed internet access to homes and businesses. Additionally, driven by the desire for minimal latency, decreased jitter, and enhanced quality of experience (QoE) in virtual reality (VR) games and cloud-based applications, there is a desire in the optical communication field to continue to grow and improve fiber access technologies.

Conventional PONs, however, have focused primarily on intensity modulation direct detection (IM-DD) technology, which has been unable to meet the needs for the emerging 100G PON standard, due to such known IM-DD limitations such as insufficient power budgets, bandwidth limitations, and transmission impairments such as chromatic dispersion (CD). Nevertheless, there is a significant desire in the industry to move even further towards next generation (NG) PONs operating up to speeds of 100 Gb/s (100G) and greater. However, conventional IM-DD technologies are lacking in cost-effective solutions to meet such growth needs.

Recent solutions based on coherent PON (CPON) technology though, have offered solutions to meeting these new high-speed demands, due to the heightened sensitivity, advanced modulation, and robust digital signal processing (DSP) exhibited by CPON, in comparison to IM-DD PONS. Various CPON technologies have been developed over time, including time-division-multiplexing (TDM) PONs, wavelength-division-multiplexing (WDM) PONs, and time-and-frequency-division multiplexing (TFDM) PONs. TFDM CPONs, for example, leverage digital subcarrier multiplexing, while also enabling versatile bandwidth sharing across time and frequency domains over a single wavelength.

Some CPON solutions have been known to implement TFDM technology to enable multiple optical signals to share the same fiber link by allocating distinct digital subcarriers to each signal. Within the allocated subcarriers, time slots facilitate data transmission from various users or services. There is a desire in the industry though, to improve upon existing CPON TFDM solutions to enable a TFDM-based CPON to more flexibly capitalize on bandwidth sharing in both the time and frequency domains without the need for colored optics.

### BRIEF SUMMARY

In an embodiment, a coherent passive optical network (CPON), includes an optical line terminal (OLT) configured to transmit a downstream optical signal to a plurality of optical network units (ONUs) disposed remotely from the OLT. The downstream optical signal including a first data subcarrier and a second subcarrier disposed adjacent the first subcarrier in the frequency domain, and a first communication subcarrier disposed between the first data subcarrier and the second subcarrier in the frequency domain. The CPON further includes an optical distribution medium in operable communication with the OLT, and configured to transport the downstream optical signal to the first and second ONUs. The CPON further includes a first ONU of the plurality of ONUS in operable communication with the optical communication medium, which first ONU has a first ONU receiver configured to receive the first data subcarrier from the downstream optical signal within a first channel bandwidth, and a first ONU transmitter configured to transmit a first upstream signal to the OLT within the first channel bandwidth. The CPON further includes a second ONU of the plurality of ONUs in operable communication with the optical communication medium, which second ONU has a second ONU receiver configured to receive the second data subcarrier from the downstream optical signal within a second channel bandwidth different from the first channel bandwidth, and a second ONU transmitter configured to transmit a second upstream signal to the OLT within the second channel bandwidth. The first communication subcarrier includes one or both of OAM management data and information for control of a media access control MAC layer.

In an embodiment, a digital signal processor (DSP) for a coherent transmitter includes a channel configuration unit for dividing a media access control (MAC) data signal into a plurality of divided frequency subcarriers, a high-speed data subprocessor for processing a set of data subcarriers from the plurality of divided frequency subcarriers, a low-speed data subprocessor for processing a set of communication subcarriers from the plurality of divided frequency subcarriers, a first plurality of channel encoders configured to individually receive and encode each data subcarrier that is output from the high-speed data subprocessor, a second plurality of channel encoders configured to individually receive and encode each communication subcarrier that is output from the low-speed data subprocessor, a post-processing unit including at least one of a pulse shaper and a digital up-converter for the plurality of encoded data and communication subcarriers, and a channel combination unit configured to combine the post-processed data and communication subcarriers into a combined output signal capable of conversion to an analog optical signal for output from the coherent transmitter.

In an embodiment, a digital signal processor (DSP) for a coherent receiver includes a digital down converter configured to (a) receive digital subcarriers from the coherent receiver, (b) extract and separate, from the received digital subcarriers, a set of data subcarriers and a set of communication subcarriers, and (c) digitally down-convert each subcarrier from the set of data subcarriers and from the set of communication subcarriers into respective baseband signals. The receiver DSP further includes a high-speed data subprocessor for individually processing each subcarrier from the set of down-converted data subcarriers, a low-speed data subprocessor for individually processing each subcarrier from the set of down-converted communication subcarriers, a first stage subprocessor for jointly processing the data subcarriers from the high-speed data subprocessor, a first plurality of channel encoders configured to individually receive and encode each data subcarrier that is output from the first stage subprocessor, and a second plurality of channel encoders configured to individually receive and encode each communication subcarrier that is output from the low-speed data subprocessor.

### BRIEF DESCRIPTION

These and other features, aspects, and advantages of the present disclosure will become better understood when the following detailed description is read with reference to the accompanying drawings in which like characters represent like parts throughout the drawings, wherein:

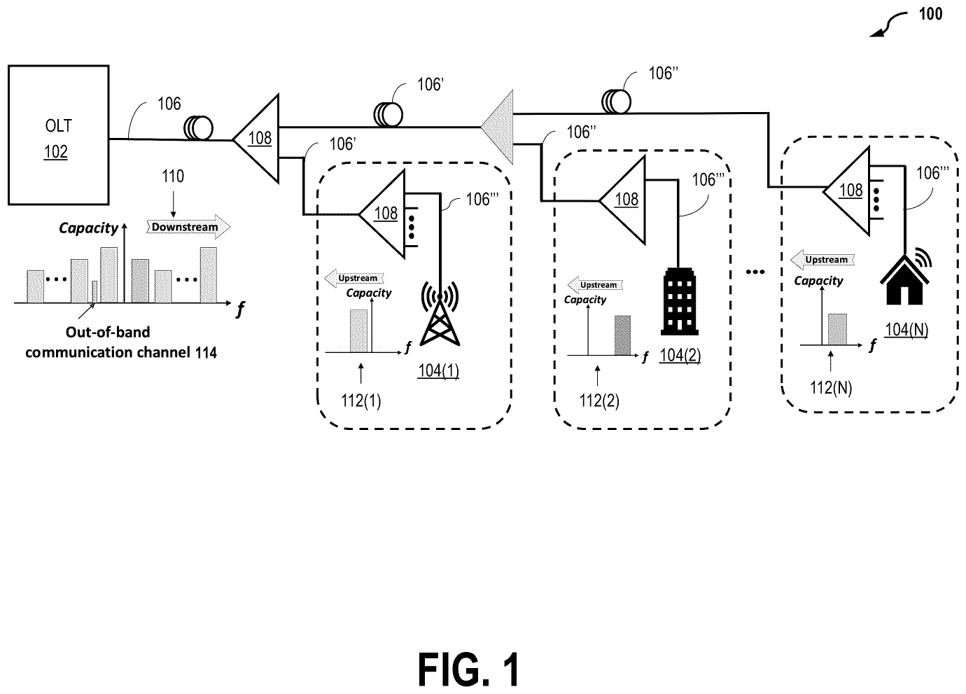

FIG. 1 is a schematic illustration depicting an exemplary hybrid coherent passive optical network system.

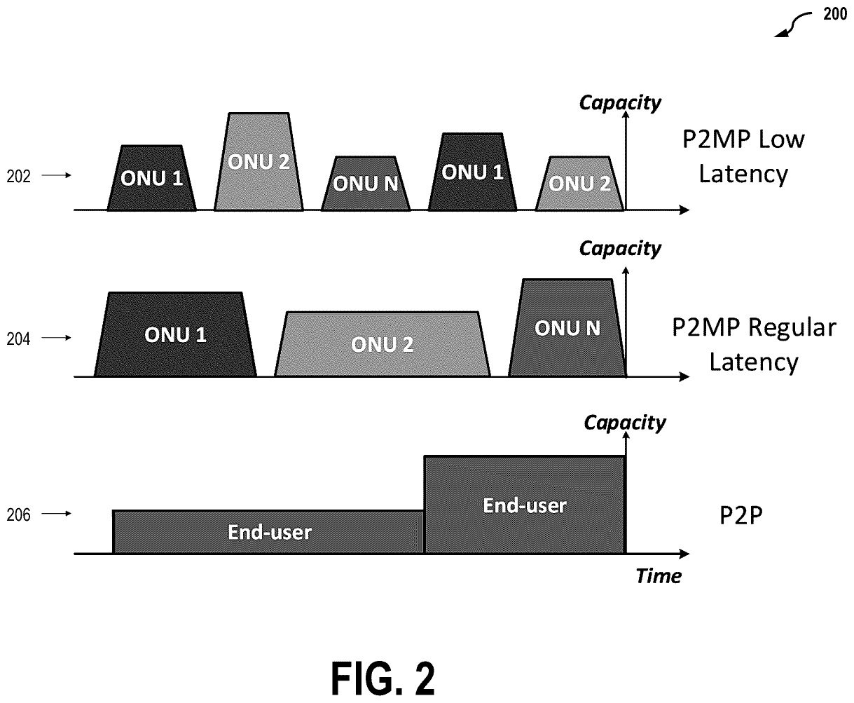

FIG. 2 depicts an exemplary distribution scheme of time-and-frequency-division multiplexing subcarriers for the hybrid coherent passive optical network system depicted in FIG. 1.

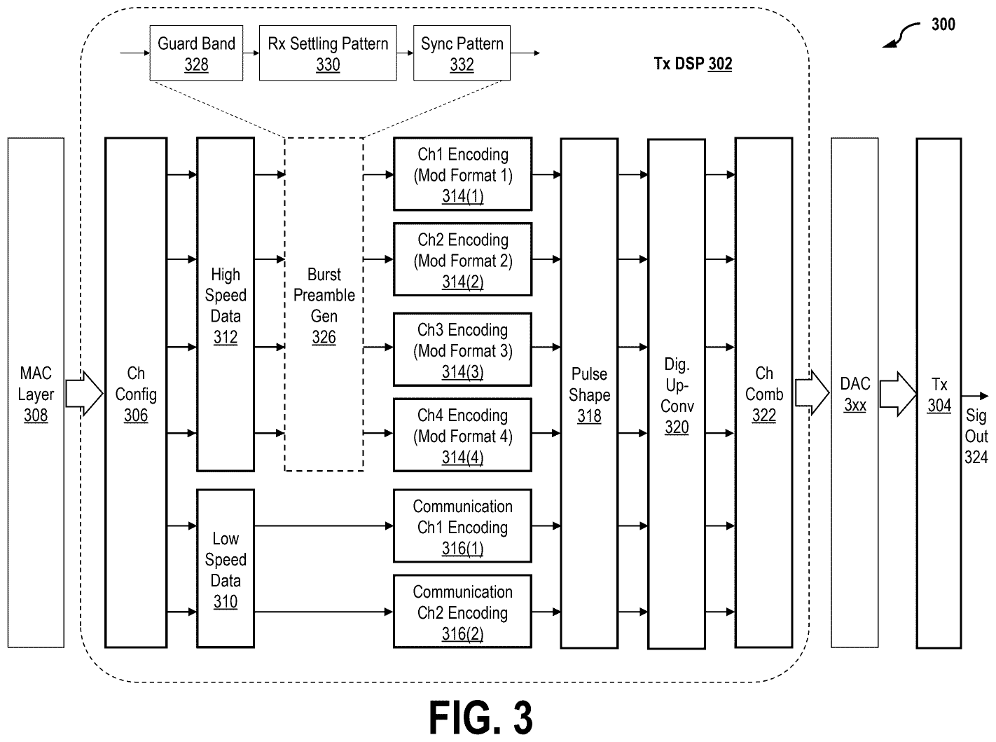

FIG. 3 is a schematic illustration depicting a logical architecture for an exemplary digital signal processor for a coherent transmitter.

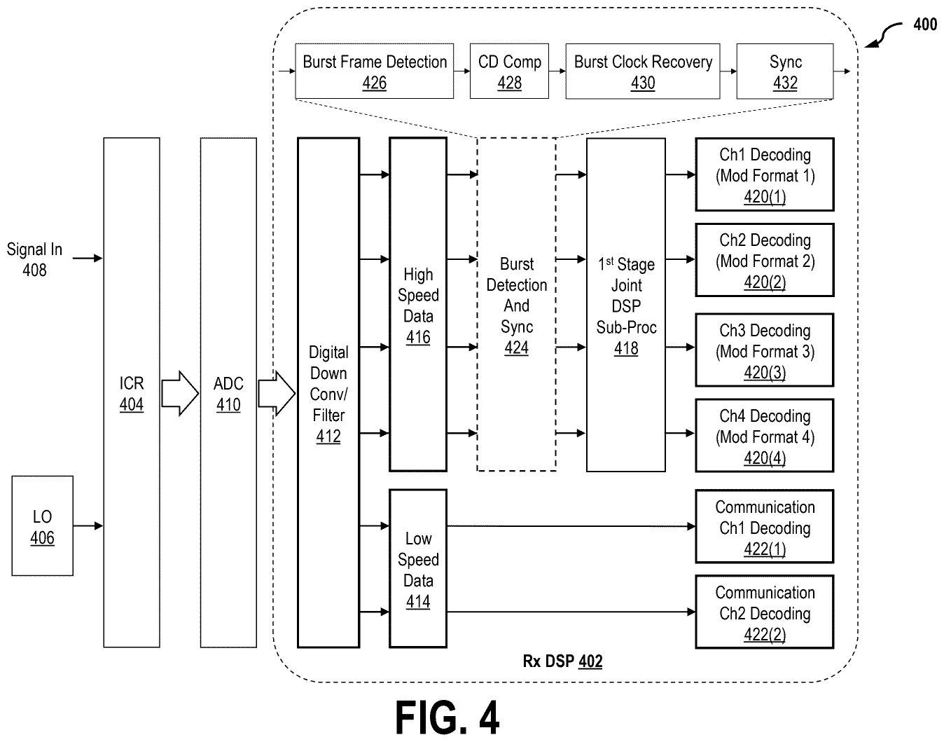

FIG. 4 is a schematic illustration depicting a logical architecture for an exemplary digital signal processor for a coherent receiver.

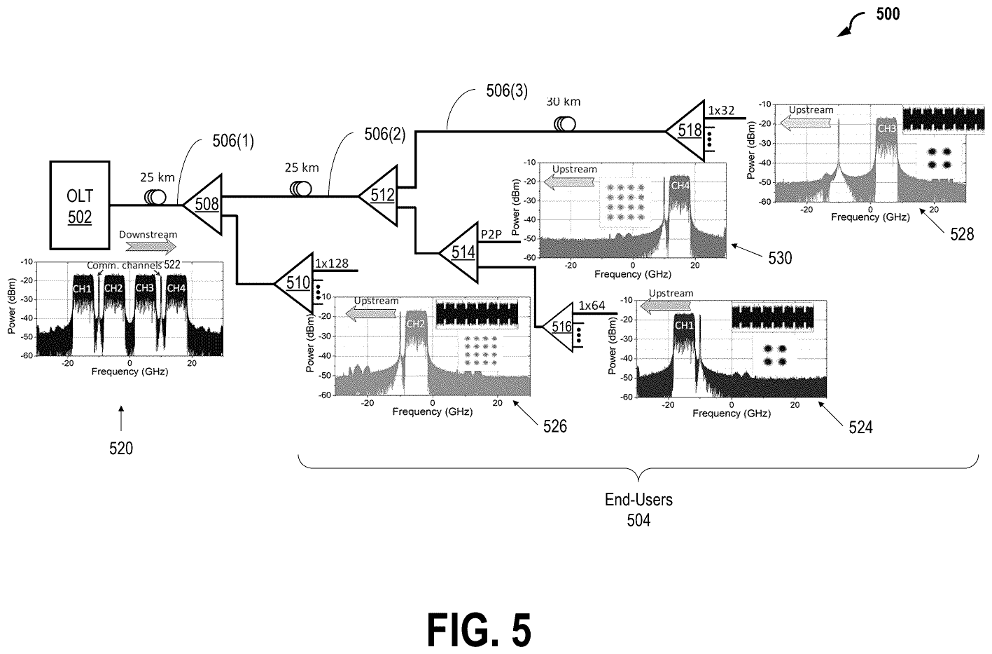

FIG. 5 is a schematic illustration of an exemplary test architecture for verifying experimental results implementing the hybrid time-and-frequency-division multiplexing coherent passive optical network embodiments herein.

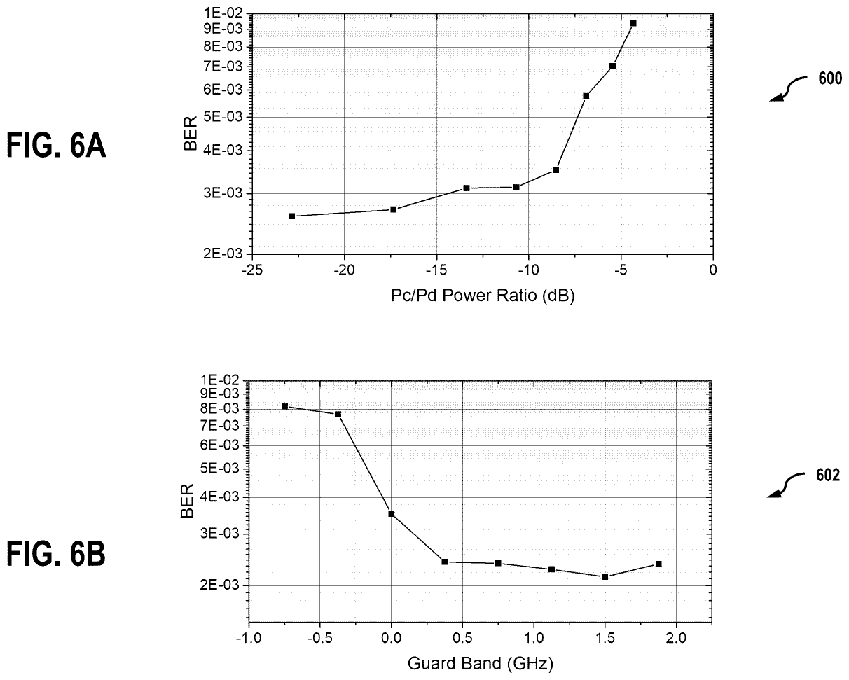

FIG. 6A is a graphical illustration depicting a influence plot obtained using the test architecture depicted in FIG. 5.

FIG. 6B is a graphical illustration depicting an impact plot obtained using the test architecture depicted in FIG. 5.

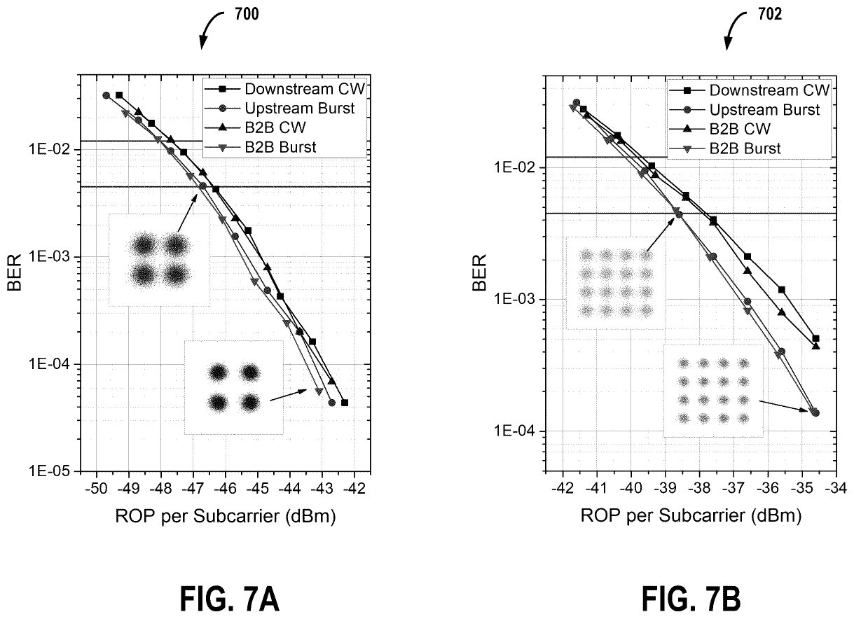

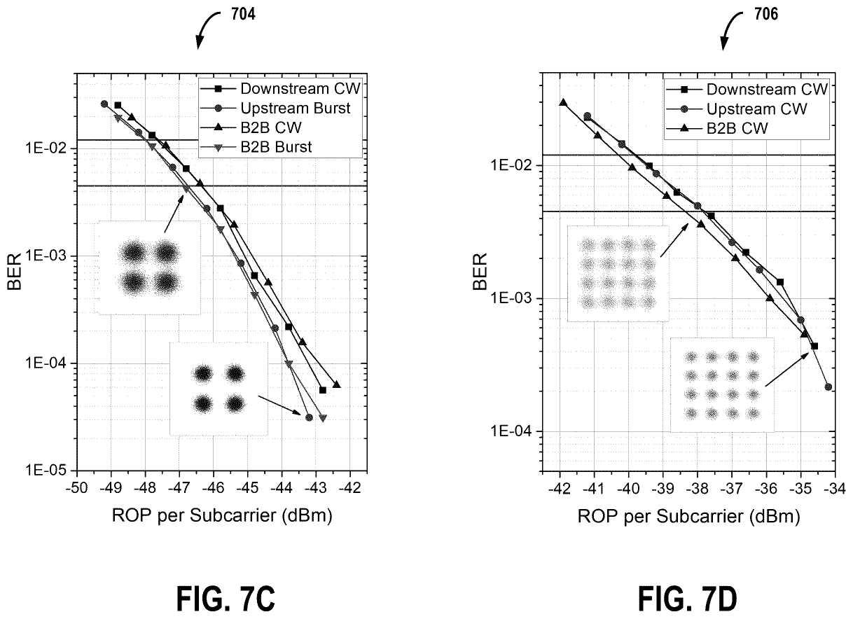

FIGS. 7A-D are graphical illustrations depicting performance plots obtained using the test architecture depicted in FIG. 5.

Unless otherwise indicated, the drawings provided herein are meant to illustrate features of embodiments of this disclosure. These features are believed to be applicable in a wide variety of systems including one or more embodiments of this disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a,” “an,” and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

As used herein, the term “database” may refer to either a body of data, a relational database management system (RDBMS), or to both, and may include a collection of data including hierarchical databases, relational databases, flat file databases, object-relational databases, object-oriented databases, and/or another structured collection of records or data that is stored in a computer system.

As used herein, the terms “processor” and “computer” and related terms, e.g., “processing device”, “computing device”, and “controller” are not limited to just those integrated circuits referred to in the art as a computer, but broadly refers to a microcontroller, a microcomputer, a programmable logic controller (PLC), an application specific integrated circuit (ASIC), and other programmable circuits, and these terms are used interchangeably herein. In the embodiments described herein, memory may include, but is not limited to, a computer-readable medium, such as a random access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

Further, as used herein, the terms “software” and “firmware” are interchangeable, and include computer program storage in memory for execution by personal computers, workstations, clients, and servers.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

Furthermore, as used herein, the term “real-time” refers to at least one of the time of occurrence of the associated events, the time of measurement and collection of predetermined data, the time for a computing device (e.g., a processor) to process the data, and the time of a system response to the events and the environment. In the embodiments described herein, these activities and events occur substantially instantaneously.

As used herein, “modem termination system” (MTS) refers to a termination unit including one or more of an Optical Network Terminal (ONT), an optical line termination (OLT), a network termination unit, a satellite termination unit, a cable modem termination system (CMTS), and/or other termination systems which may be individually or collectively referred to as an MTS.

As used herein, “modem” refers to a modem device, including one or more a cable modem (CM), a satellite modem, an optical network unit (ONU), a DSL unit, etc., which may be individually or collectively referred to as modems.

As used herein, the term “coherent transceiver,” unless specified otherwise, refers to a P2P or P2MP coherent optics transceiver having a coherent optics transmitting portion and a coherent optics receiving portion. In some instances, the transceiver may refer to a specific device under test (DUT) for several of the embodiments described herein.

As described herein, a “PON” generally refers to a passive optical network or system having components labeled according to known naming conventions of similar elements that are used in conventional PON systems. For example, an OLT may be implemented at an aggregation point, such as a headend/hub, and multiple ONUs may be disposed and operable at a plurality of end user, customer premises, or subscriber locations. Accordingly, an “uplink transmission” refers to an upstream transmission from an end user to a headend/hub, and a “downlink transmission” refers to a downstream transmission from a headend/hub to the end user, which may be presumed to be generally broadcasting continuously (unless in a power saving mode, or the like).

The person of ordinary skill in the art will understand that the term “wireless,” as used herein in the context of optical transmission and communications, including free space optics (FSO), generally refers to the absence of a substantially physical transport medium, such as a wired transport, a coaxial cable, or an optical fiber or fiber optic cable.

As used herein, the term “data center” generally refers to a facility or dedicated physical location used for housing electronic equipment and/or computer systems and associated components, e.g., for communications, data storage, etc. A data center may include numerous redundant or backup components within the infrastructure thereof to provide power, communication, control, and/or security to the multiple components and/or subsystems contained therein. A physical data center may be located within a single housing facility, or may be distributed among a plurality of co-located or interconnected facilities. A ‘virtual data center’ is a non-tangible abstraction of a physical data center in a software-defined environment, such as software-defined networking (SDN) or software-defined storage (SDS), typically operated using at least one physical server utilizing a hypervisor. A data center may include as many as thousands of physical servers connected by a high-speed network.

As used herein, the term “hyperscale” refers to a computing environment or infrastructure including multiple computing nodes, and having the capability to scale appropriately as increased demand is added to the system, i.e., seamlessly provision infrastructure components and/or add computational, networking, and storage resources to a given node or set of nodes. A hyperscale system, or “hyperscaler” may include hundreds of data centers or more, and may include distributed storage systems. A hyperscale system may utilize redundancy-based protection and/or erasure coding, and may be typically configured to increase background load proportional to an increase in cluster size. A hyperscale node may be a physical node or a virtual node, and multiple virtual nodes may be located on the same physical host. Hyperscale management may be hierarchical, and a “distance” between nodes may be physical or perceptual. A hyperscale datacenter may include several performance optimized datacenters (PODs), and each POD may include multiple racks and hundreds and thousands of compute and/or storage devices.

Exemplary architectures of CPON architectures, as well as the respective components thereof, are also described in greater detail in U.S. Pat. Nos. 9,912,409, 10,200,123, and 10,523,356. Exemplary systems and methods for coherent burst reception are described in greater detail in co-pending U.S. patent application Ser. No. 17/401,473, filed Aug. 13, 2021, and Ser. No. 17/346,940, filed Jun. 14, 2021. An exemplary rate-flexible CPON is described in co-pending U.S. patent application Ser. No. 18/905,880, filed Oct. 3, 2024. The disclosures of all of these prior patents and patent applications are incorporated by reference herein in their entireties.

In an exemplary embodiment, systems and methods for an innovative hybrid TFDM CPON are provided. According to the present techniques, the present hybrid TFDM CPON architecture is capable of achieving an aggregated capacity of 150 Gb/s, and with significantly improved flexibility enabling adaptable modulation formats across subcarriers. In an embodiment, the hybrid TFDM CPON further enables data rates of 25 Gb/s or 50 Gb/s per subcarrier, and including upstream burst transmission. In an embodiment, supplementary communication channels are incorporated for various application scenarios, therefore rendering the present hybrid TFDM CPON exceptionally versatile for optical access requirements.

As described further below in greater detail, the present embodiments are applicable to continuous downstream transmission and upstream burst transmission; however, the person of ordinary skill in the art will understand that such description is provided by way of example, and is not intended to be limiting. The terms “downstream” and “upstream,” for example, are relative, and are used herein as points of reference to distinguish one direction of transmission with respect to another direction across a CPON.

FIG. 1 is a schematic illustration depicting an exemplary hybrid CPON system 100. In the exemplary embodiment depicted in FIG. 1, hybrid CPON system 100 features adaptive capacity and distributed splitting, and includes a centralized optical line terminal (OLT) 102 in operable communication with a plurality (i.e., 1−N) of end-users 104 (e.g., including respective transceivers thereof, such as ONUs, customer premises equipment (CPEs), modems, etc.) over an optical communication medium 106 branching to respective end-users 104 through a plurality of splitters 108 connecting the various portions of optical communication medium 106 in serial and/or in parallel. In an embodiment, OLT 102 may be located within a central office, a communications hub, or a headend of an optical link (not separately shown in FIG. 1), and functions to convert standard signals from a service provider (also not shown) to the various frequencies, modulation formats, and framing used by hybrid CPON system 100. In an embodiment, optical communication medium 106 may include a single mode fiber (SMF), and one or more splitters 108 may include a passive splitter and/or a power splitter/combiner.

In an exemplary embodiment, hybrid CPON system 100 implements TFDM technology to enable multiple optical signals to share the same fiber link (e.g., optical communication medium 106) by allocating distinct digital subcarriers to each signal to and from a respective end-user 104. In an embodiment, within each allocated subcarrier, time slots facilitate data transmission to/from various users or services. That is, hybrid CPON system 100 is shown to illustrate a hybrid point-to-multipoint (P2MP) design concept that includes point-to-point (P2P) portions to incorporate multiple modulation formats into a downstream optical signal 110 from the OLT to respective end-users 104 having varying link budgets to serve to customers in different locations and at different respective distances from OLT 102.

In the exemplary embodiment depicted in FIG. 1, a first end-user 104(1) is illustrated as a high-capacity, short-reach user, and accordingly may utilize a higher-order modulation format (e.g., 16 quadrature amplitude modulation (16QAM) or 64QAM) to receive a portion of downstream optical signal 110, or for one or more respective upstream optical signals 112(1) transmitted from end-user 104(1) to OLT 102. Similarly, a second end-user 104(2) is illustrated as a medium-capacity, medium-reach user, and accordingly may desire a lower-order modulation format (e.g., 16QAM) for its upstream optical signal 112(2) than first end-user 104(1). An Nth end-user 104(N) is illustrated as a low-capacity, long-reach user, and thus may desire an even lower order modulation format (e.g., quadrature phase shift keying (QPSK)) for its respective upstream optical signal(s) 112(N).

In this example, for non-limiting illustrative purposes, first and Nth end users 104(1), 104(N) are depicted as P2MP links, whereas second end-user 104(2) is depicted as a P2P link. Additionally, downstream optical signal 110 is depicted as including at least one out-of-band (OoB) communication channel 114.

According to the exemplary embodiment depicted in FIG. 1, OLT 102 is configured to manage transmission and reception of digital subcarriers to and from respective individual ONUs of end-users 104, such that the respective ONUs are enabled to modulate and/or demodulate its specific subcarriers, according to the varying capacity of the particular end-user 104. Accordingly, in comparison with conventional techniques, hybrid CPON system 100 demonstrates superior versatility to capitalize on bandwidth sharing, in both the time and frequency domains. Using an innovative implementation of TFDM technology, systems and methods according to hybrid CPON system 100 advantageously avoid the need for colored optics.

The person of ordinary skill in the art will appreciate that these depictions are provided by way of example, and are not intended to be limiting. Other and/or additional modulation formats may be implemented without departing from the scope herein, and for a variety of different reach lengths and/or architectural topologies.

FIG. 2 depicts an exemplary distribution scheme 200 of TFDM subcarriers for hybrid CPON system 100, FIG. 1. More particularly, according to hybrid CPON system 100, distinct frequency bands of TFDM subcarriers may be designated for network services and/or groups of ONUs based on the unique latency or capacity requirements of the particular service or ONU. For example, a first subcarrier distribution 202 depicts an illustrative example of frequency signal designations (e.g., as downstream continuous optical signal 110, and/or as aggregated upstream burst optical signals 112, FIG. 1) for a low-latency P2MP approach. A second subcarrier distribution 204 depicts an illustrative example of frequency signal designations for a regular-latency P2MP approach. Additionally, or alternatively, respective TFDM subcarriers may be designated according to a third subcarrier distribution 206, which is based on the different capacity requirements of respective end-users (e.g., end-users 104, FIG. 1).

The person of ordinary skill in the art will understand that exemplary subcarrier distributions 202, 204, 206 are provided by way of illustration, and are not intended to be limiting. The advantageous techniques of hybrid CPON system 100 enable significant flexibility for digital subcarrier management (e.g., by OLT 102, FIG. 1) in consideration of various end-user parameters or requirements, considered individually or together, including without limitation capacity, latency, topology (e.g., P2P and/or P2MP), and distance from the OLT.

FIG. 3 is a schematic illustration depicting a logical architecture 300 for an exemplary digital signal processor (DSP) 302 for a coherent transmitter 304. In the exemplary embodiment depicted in FIG. 3, transmitter DSP 302 is configured to support various modulation formats and/or digital subcarrier capacities. In an exemplary embodiment, transmitter DSP 302 is configured to receive, at a channel configuration unit 306, data from a MAC layer 308. Channel configuration unit 306 is configured to divide data received from MAC layer 308 into respective frequencies subcarriers. In an exemplary embodiment, channel configuration unit 306 divides the MAC layer data into (a) a set of communication subcarriers (e.g., low-speed) for delivery to a low-speed data subprocessor 310, and (b) a set of data subcarriers (e.g., high-speed) for delivery to a high-speed data subprocessor 312.

In an exemplary operation of transmitter DSP 302, each data subcarrier from high-speed data subprocessor 312 is individually encoded and assigned to specific frequency bands by a respective data channel encoder 314 (i.e., four data channel encoders 314(1-4), in this example). In an exemplary embodiment, data subcarriers for CH1 and CH3 may include DP-QPSK signals at 6.25 GBd, whereas data subcarriers for CH2 and CH4 may include DP-16QAM signals, also at 6.25 GBd (see e.g., FIGS. 7A-D, below).

In a similar manner, each communication subcarrier from low-speed data subprocessor 310 is individually encoded by a respective communication channel encoder 316 (i.e., two data channel encoders 316(1-2), in this example). In the exemplary embodiment, the two communication subcarriers run at 312.5 MBd using a DP-QPSK modulation format; however, the person of ordinary skill in the art will understand that, according to the innovative techniques provided herein, the respective communication subcarriers may alternatively employ other modulation formats, such as unipolar/bipolar NRZ or BPSK, and/or other modulation formats that do not require high capacity. In an exemplary embodiment, the communication subcarriers may incorporate one or more OoB communication subcarriers (e.g., from OoB communication channel 114, FIG. 1) for MAC layer control signals and OAM management data.

In further exemplary operation of transmitter DSP 302, a pulse shaping unit 318 applies Nyquist pulse shaping to each of the encoded and modulated data subcarriers, and also to each of the encoded communication subcarriers. Each of the pulse-shaped subcarriers may then be up-converted to specific respective inter-frequencies by a digital up-converter 320. A channel combination unit 322 is then configured to combine the several digital data frames from the data subcarriers and communication subcarriers into an aggregated signal, which then may be converted by a digital-to-analog converter (DAC) 324 into an analog signal for transmission by coherent transmitter 304 (e.g., of OLT 102, FIG. 1) as an output optical signal 324 (e.g., downstream optical signal 110, FIG. 1).

For upstream optical signals (e.g., upstream optical signals 112, FIG. 1), transmitter DSP 302 may be additionally configured for implementation with respect to one or more ONU burst transmitters of respective end-users (e.g., end-users 104, FIG. 1). In this case, transmitter DSP 302 for an ONU may further include a burst preamble generator 326 disposed between high-speed data subprocessor 312 and data channel encoders 314 to generate burst frames for the respective high-speed data subcarriers. Accordingly, burst preamble generator 326 may include one or more of a guard band generator 328, a receiver settling pattern generator 330, and a synchronization pattern generator 332, such that payload data of the respective high-speed data subcarriers may be configured with respective burst frame preambles that include information regarding guard bands, receiver settling patterns, and synchronization patterns. In the case of a continuous signal (e.g., from OLT 102, FIG. 1), burst frame generation may be optional, or unnecessary.

In the exemplary embodiment, transmitter DSP 302 is further enabled to assign different modulation formats to different time frames within each data subcarrier, thereby advantageously providing superior flexibility and capacity for time-domain sharing, particularly in the case where it is desirable to implement the time-domain flexible rate and modulation format identification techniques described in co-pending U.S. patent application Ser. No. 18/905,880. The person of ordinary skill in the art will understand that the different respective techniques of these two co-pending applications may be implemented together in a complementary and non-exclusive fashion.

FIG. 4 is a schematic illustration depicting a logical architecture 400 for an exemplary digital signal processor 402 for a coherent receiver 404. In the exemplary embodiment depicted in FIG. 4, architecture 400 is similar, in several aspects, to architecture 300, FIG. 3, and therefore includes several elements that serve as a functional counterparts to respective elements of architecture 300. Accordingly, according to architecture 400, DSP 402 is also advantageously configured to support various modulation formats and/or digital subcarrier capacities.

In exemplary operation of receiver architecture 400, coherent receiver 404 (e.g., an integrated coherent receiver (ICR)) is in operable communication with a local oscillator (LO) 406, and is configured to receive both an LO signal therefrom, and also an input analog optical signal 408 (e.g., downstream optical signal 110 from OLT 102, upstream optical signals 112 from respective end-user ONUs, FIG. 1) from an optical communication medium (e.g. optical communication medium 106, FIG. 1). The received analog signals are then converted into digital signals by an analog-to-digital converter (ADC) 410 prior to processing by receiver DSP 402.

In exemplary operation of receiver DSP 402, a digital down-converter and filter 412 extracts and separates subcarriers of the digital signals, and digitally down-converts each such extracted/separated into respective baseband signals. Similar to some of the functionality of channel configuration unit 306, FIG. 3, digital down-converter and filter 412 is configured to divide the separate baseband signals into (a) a set of low-speed communication subcarriers for delivery to a low-speed data subprocessor 414, and (b) a set of high-speed data subcarriers for delivery to a high-speed data subprocessor 416, thereby enabling handling of both high-speed data subcarriers and low-speed communication subcarriers independently.

In further exemplary operation of receiver DSP 402, the respective baseband data subcarriers from high-speed data subprocessor 416 undergo conventional first stage DSP processing by a first stage joint DSP subprocessor 418. That is, in an exemplary embodiment, the conventional first stage joint DSP may be executed the same (e.g., up to application of a constant modulus algorithm (CMA)) for each baseband data subcarrier irrespective of its particular modulation format. The conventionally-processed data subcarriers are then subject to decoding and second stage DSP processing by a respective data channel decoder 420. Respective baseband communication subcarriers from low-speed data subprocessor 414, on the other hand, may be fed directly to respective communication channel decoders 422.

In an exemplary embodiment, each data channel decoder may be configured to process a respective data subcarrier according to the modulation format thereof. For example, data subcarriers using lower-order modulation formats (e.g., QPSK) may adequately processed in the second stage using a multi-modulus algorithm (MMA) and carrier phase estimation (CPE) techniques. In the case of higher-order modulation format data subcarriers though (e.g., 16QAM and higher), it may be desirable to additionally implement one or more of a K-means algorithm and a Gaussian mixture model (GMM) algorithm for more precise results. The person of ordinary skill in the art will understand that these particular modulation formats are provided by way of illustration, and are not intended to be limiting. The respective data subcarriers may utilize one or more of DP-8QAM, DP-32QAM, DP-64QAM, and probabilistic constellation shaping (PCS) formatting without departing from the scope herein.

In the case where input analog optical signal 408 represents an upstream optical signal (e.g., upstream optical signals 112, FIG. 1), namely, where receiver DSP 402 is implemented for one or more burst receivers in an OLT (e.g., OLT 102, FIG. 1), receiver DSP 402 may further include a burst detection and synchronization unit 424 disposed between respective high-speed data subprocessors 416 and first stage joint DSP subprocessor 418 to enable detection and handling of upstream burst frames. Accordingly, burst detection and synchronization unit 424 may include one or more of a power-based burst frame detection module 426, a chromatic dispersion (CD) compensation module 428, a burst clock recovery module 430, and synchronization module 432 configured to implement a double-correlation-based burst frame synchronization algorithm.

Thus, in the case of received coherent burst signals, only the respective payload portions of the received burst signals may be subject to conventional first-stage coherent DSP processing by first stage joint DSP subprocessor 418. In contrast, in the case where receiver DSP 402 is implemented in an ONU receiver, burst detection by burst detection and synchronization unit 424 may be optional or unnecessary, since an ONU receiver will typically receive continuous mode signals from its OLT.

### Experimental Demonstrations

To demonstrate utility of the above embodiments, an experimental setup was configured to demonstrate a real-world implementation of hybrid scene upon system 100, FIG. 1. More particularly, advantageous benefits realized according to the present hybrid TDFM CPON techniques were, as described further below with respect to FIGS. 5-7D, demonstrated through experimental validation. The experimental results verify the capability of the present hybrid TFDM CPON to effectively accommodate distributed splitting configurations across varying distances and split ratios, for example, ranging from 25 km with 128 splits, to 80 km with 32 splits, as well as a 50 km P2P link.

FIG. 5 is a schematic illustration of an exemplary test architecture 500 for verifying experimental results implementing the hybrid TFDM CPON embodiments herein. More particularly, test architecture 500 implemented a real-world operation of a hybrid TFDM CPON, and included an OLT 502 operably coupled to various ONUs of respective end-users 504 through a number of dedicated optical fiber segments 506. For this experiment, a first fiber segment 506(1) connected OLT 502 to a first splitter 508 over a 25 km length. From first splitter 508, a second splitter 510 was configured to implement a 1×128 split ratio for a plurality of high-capacity, short-reach end-users 504 in a P2MP topology (e.g., 128 splits, 25 km from OLT 502).

A second fiber segment 506(2), also of 25 km, connected to first splitter 508 to a third splitter 512 to service high-capacity, medium-reach end-users 504 according to both P2P and P2MP topologies. That is, from third splitter 512, a fourth splitter 514 was configured to split the 50 km signal (i.e., from OLT 502) for delivery to one high-capacity, medium-reach end-user 504 in a P2P topology, and to a plurality of high-capacity, medium-reach end-users 504 through a fifth splitter 516 implementing a 1×64 split ratio for a P2MP topology at 50 km from OLT 502.

A third fiber segment 506(s) of 30 km connected to third splitter 512 to a sixth splitter 518 to service lower-capacity, long-reach end-users 504 according to a P2MP topology. That is, sixth splitter 518 was configured to implement a 1×32 split ratio for a plurality of low-capacity, long-reach end-users 504 in a P2MP topology (e.g., 32 splits at 80 km from OLT 502).

From this configuration for test architecture 500, experimental validations were conducted to assess the performance of the present TFDM hybrid CPON embodiments over a variety of adaptable data rates and link budgets. More particularly, from OLT 502 a downstream signal 520 was propagated, which included four sequential data subcarriers CH1, CH2, CH3, CH4, and also two OoB communication subcarriers 522 disposed between data subcarriers CH1 and CH2, and between data subcarriers CH3 and CH4. For this experimental validation, data subcarriers CH1 and CH3 utilized a 6.25 GBd DP-QPSK modulation, and data subcarriers CH2 and CH4 utilized a 6.25 GBd DP-16QAM modulation. Communication subcarriers 522 each operated at 312.5 MBd using DP-QPSK modulation.

For this experiment, one communication subcarrier 522 (between data subcarriers CH1 and CH2, in this example) was reserved for P2MP applications (e.g., MAC control signals and OAM information), and the other communication subcarrier 522 (between data subcarriers CH3 and CH4, in this example) was reserved for P2P scenarios. In this manner, the P2MP communication subcarrier 522 was utilized by a first upstream signal 524 using the frequency band for data subcarrier CH1 (e.g., 50 km, 64 split, medium-reach P2MP end-users 504), a second upstream signal 526 using the frequency band for data subcarrier CH2 (e.g., 25 km, 128 split, short-reach P2MP end-users 504), and a third upstream signal 528 using the frequency band for data subcarrier CH3 (e.g., 80 km, 32 split, long-reach P2MP end-users 504). In comparison, the P2P communication subcarrier 522 was utilized by a fourth upstream signal 530 using the frequency band for data subcarrier CH4 (e.g., 50 km, medium-reach P2P end-user 504).

Thus, as demonstrated by test architecture 500, an optical distribution network (ODN) may be advantageously configured to cater to a variety of distributed splitting and connectivity requirements, thereby offering significantly superior flexibility when compared with conventional techniques. In some instances, subcarriers modulated by QPSK may be more desirable to support medium to long-range services having substantial link budgets, whereas 16QAM subcarriers may be desirable for higher capacity services over shorter- to medium-range links. In the exemplary embodiment depicted in FIG. 5, CH1 supported a 50 km reach with a 1×64 split, CH3 extended to 80 km with a 1×32 split for medium to long-range services, CH2 provided P2MP services over a 25 km link with a 1×128 split, and CH4 facilitated P2P services across a 50 km fiber link. In the upstream direction, CH1, CH2, and CH3 transmitted TFDM burst signals, whereas CH4 operated continuously to support P2P service.

In an embodiment, it may be desirable to position OoB communication subcarriers 522 between respective TFDM data subcarriers based on the impact of the position OoB communication subcarrier on its neighboring TFDM data subcarriers. For example, in some cases, a communication subcarrier 522 may be able to affect power distribution and signal-to-noise ratio (SNR) of neighboring data subcarriers. In such instances, communication subcarriers 522 may be further configured to include a guard band between the particular communication subcarrier and its neighboring data subcarriers.

FIG. 6A is a graphical illustration depicting an influence plot 600 obtained using test architecture 500, FIG. 5. More particularly, influence plot 600 illustrates the influence of the ratio between the communication subcarrier power, Pc, and the data subcarrier power, Pd, namely, the Pc/Pd power ratio on the data carrier bit-error-rate (BER) performance. As may be seen from influence plot 600, the data subcarrier performance remains substantially unaffected when the Pc/Pd power ratio is below approximately −8.5 dB.

FIG. 6B is a graphical illustration depicting an impact plot 602 obtained using test architecture 500, FIG. 5. More particularly, impact plot 602 illustrates the impact of guard band size (in GHz) on BER performance. To obtain impact plot 602, the Pc/Pd power ratio was kept relatively constant at −10 dB. As may be seen from impact plot 602, no data subcarrier performance penalty was observed for guard band sizes exceeding 0.5 GHz. For the additional experimental test results described below with respect to FIGS. 7A-D, a guard band of 1.875 GHz was maintained for minimal data subcarrier impact.

FIGS. 7A-D are graphical illustrations depicting performance plots 700, 702, 704, 706, respectively, obtained using test architecture 500, FIG. 5. That is, to assess the performance of the hybrid TFDM CPON of test architecture 500 for both continuous (CW) downstream and burst upstream transmission, TFDM subcarrier CH1, CH2, CH3, CH4 was individually analyzed for BER relative to received optical power (ROP), along with their corresponding constellation diagrams. For each of performance plots 700, 702, 704, 706, upstream and downstream BER vs. ROP results are superimposed with comparative Back-to-Back (B2B) results, along with thresholds for hard-decision and soft-decision forward error correction (FEC).

Accordingly, performance plot 700, FIG. 7A, illustrates the BER performance of TFDM subcarrier CH1 measured for a continuous downstream, burst upstream, continuous B2B, and burst B2B. Similarly, performance plot 702, FIG. 7B, illustrates similar BER performance results for TFDM subcarrier CH2, and performance plot 704, FIG. 7C, illustrates similar BER performance results for TFDM subcarrier CH3. In contrast, performance plot 706, FIG. 7D, illustrates measured results for P2P services (e.g., upstream P2P signal 530, FIG. 5), and therefore depicts superimposed performance results for continuous mode transmission in both the downstream and upstream directions, as well as B2B. The person of ordinary skill in the art may therefore observe, from performance plots 700, 702, 704, 706, that the present hybrid TFDM CPON systems and methods provide significant versatility and effectiveness for both continuous and burst signals, while also advantageously accommodating various user capacities, link budgets, distances, and other scenarios without sacrificing robust system performance.

As described herein, innovative hybrid TFDM CPON techniques and architectures are provided that advantageously enable adaptable modulation formats across multiple subcarriers and additional communication channels for diverse applications and end-user needs/requirements. Experimental validation results further demonstrate the flexibility of the present hybrid TFDM CPON to accommodate distributed splitting over various distances (e.g., 25 km/128 split, 50 km/64 split, 80 km/32 split) for respective P2MP topologies, and with direct connections for P2P topologies (e.g., 50 km/P2P link). The present embodiments further feature utilization of OoB communication subcarriers advantageously disposed between respective data channel subcarriers. Systems and methods utilizing the present hybrid CPON techniques may be additionally useful with respect to the ongoing adoption of a full-duplex (FDX) coherent optical network configurations and topologies, where a single fiber link within a CPON accommodates both downstream and upstream transmissions utilizing a same wavelength.

Exemplary embodiments for hybrid TFDM CPONs are described above in detail. The systems and methods of this disclosure though, are not limited to only the specific embodiments described herein, but rather, the components and/or steps of their implementation may be utilized independently and separately from other components and/or steps described herein. Additionally, the exemplary embodiments can be implemented and utilized in connection with other access networks utilizing fiber and coaxial transmission at the end user stage.

As described above, the DOCSIS protocol may be substituted with, or further include protocols such as EPON, RFoG, GPON, Satellite Internet Protocol, without departing from the scope of the embodiments herein. The present embodiments are therefore particularly useful for communication systems implementing a DOCSIS protocol, and may be advantageously configured for use in existing 4G and 5G networks, and also for new radio (NR), 5G-NR, 6G, and future generation network implementations.

Although specific features of various embodiments of the disclosure may be shown in some drawings and not in others, such illustrative techniques are for convenience only. In accordance with the principles of the disclosure, a particular feature shown in a drawing may be referenced and/or claimed in combination with features of the other drawings.

Some embodiments involve the use of one or more electronic or computing devices. Such devices typically include a processor or controller, such as a general purpose central processing unit (CPU), a graphics processing unit (GPU), a microcontroller, a reduced instruction set computer (RISC) processor, an application specific integrated circuit (ASIC), a programmable logic circuit (PLC), a field programmable gate array (FPGA), a digital signal processor (DSP) device, and/or any other circuit or processor capable of executing the functions described herein. The processes described herein may be encoded as executable instructions embodied in a computer readable medium, including, without limitation, a storage device and/or a memory device. Such instructions, when executed by a processor, cause the processor to perform at least a portion of the methods described herein. The above examples are exemplary only, and thus are not intended to limit in any way the definition and/or meaning of the term “processor.”

This written description uses examples to disclose the embodiments, including the best mode, and also enables a person skilled in the art to practice the embodiments, including the make and use of any devices or systems and the performance of any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A coherent passive optical network (CPON), comprising:
an optical line terminal (OLT) configured to transmit a downstream optical signal to a plurality of optical network units (ONUs) disposed remotely from the OLT, the downstream optical signal including (a) a first data subcarrier and a second subcarrier disposed adjacent the first subcarrier in the frequency domain, and (b) a first communication subcarrier disposed between the first data subcarrier and the second subcarrier in the frequency domain;
an optical distribution medium (a) in operable communication with the OLT, and (b) configured to transport the downstream optical signal to the first and second ONUs;
a first ONU of the plurality of ONUs (a) in operable communication with the optical communication medium, and (b) including (i) a first ONU receiver configured to receive the first data subcarrier from the downstream optical signal within a first channel bandwidth, and (ii) a first ONU transmitter configured to transmit a first upstream signal to the OLT within the first channel bandwidth; and
a second ONU of the plurality of ONUs (a) in operable communication with the optical communication medium, and (b) including (i) a second ONU receiver configured to receive the second data subcarrier from the downstream optical signal within a second channel bandwidth different from the first channel bandwidth, and (ii) a second ONU transmitter configured to transmit a second upstream signal to the OLT within the second channel bandwidth,
wherein the first communication subcarrier includes one or both of OAM management data and information for control of a media access control MAC layer.

2. The CPON of claim 1, wherein the first and second data subcarriers utilize a same modulation format.

3. The CPON of claim 1, wherein the first and second data subcarriers utilize a different respective modulation format.

4. The CPON of claim 1, wherein the first ONU is disposed at a first distance from the OLT, and wherein the second ONU is disposed at a second distance from the OLT greater than the first distance.

5. The CPON of claim 4, wherein the first distance is 25 km, and wherein the second distance is 50 km.

6. The CPON of claim 4, wherein the first ONU is a short-reach ONU with respect to the OLT, and wherein the second ONU is a medium-reach ONU with respect to the OLT.

7. The CPON of claim 4, wherein the first distance is 25 km, and wherein the second distance is 80 km.

8. The CPON of claim 4, wherein the first ONU is a short-reach ONU with respect to the OLT, and wherein the second ONU is a long-reach ONU with respect to the OLT.

9. The CPON of claim 8, wherein the second ONU is considered lower-capacity relative to a capacity of the first ONU.

10. The CPON of claim 4, wherein the first and second ONUs are each configured for a point-to-multipoint (P2MP) split ratio.

11. The CPON of claim 10, wherein the first ONU is configured for a 1×128 split ratio, and wherein the second ONU is configured for a 1×64 split ratio.

12. The CPON of claim 10, wherein the first ONU is configured for a 1×128 split ratio, and wherein the second ONU is configured for a 1×32 split ratio.

13. The CPON of claim 1, further comprising;
a third ONU of the plurality of ONUs (a) in operable communication with the optical communication medium, and (b) including (i) a third ONU receiver configured to receive a third data subcarrier from the downstream optical signal within a third channel bandwidth adjacent the second frequency bandwidth, and (ii) a third ONU transmitter configured to transmit a third upstream signal to the OLT within the third channel bandwidth; and
a fourth ONU of the plurality of ONUs (a) in operable communication with the optical communication medium, and (b) including (i) a fourth ONU receiver configured to receive the fourth data subcarrier from the downstream optical signal within a fourth channel bandwidth adjacent the third channel bandwidth, and (ii) a fourth ONU transmitter configured to transmit a fourth upstream signal to the OLT within the fourth channel bandwidth,
wherein the downstream optical signal further includes a second communication subcarrier disposed between the third and fourth data subcarriers.

14. The CPON of claim 13, wherein the second communication subcarrier is dedicated for P2P operation.

15. The CPON of claim 14, wherein the first, second, and third ONUs utilize the first communication subcarrier and are each configured for a point-to-multipoint (P2MP) split ratio, and wherein the fourth ONU utilizes the second communication subcarrier and is configured for P2P transport.

16. The CPON of claim 13, wherein the first and second communication subcarriers are each transported within a frequency bandwidth substantially narrower than each of the first, second, third, and fourth channel bandwidths.

17. A digital signal processor (DSP) for a coherent transmitter, comprising:
a channel configuration unit configured to divide a media access control (MAC) data signal into a plurality of divided frequency subcarriers;
a high-speed data subprocessor for processing a set of data subcarriers from the plurality of divided frequency subcarriers;
a low-speed data subprocessor for processing a set of communication subcarriers from the plurality of divided frequency subcarriers;
a first plurality of channel encoders configured to individually receive and encode each data subcarrier that is output from the high-speed data subprocessor;
a second plurality of channel encoders configured to individually receive and encode each communication subcarrier that is output from the low-speed data subprocessor;
a post-processing unit including at least one of a pulse shaper and a digital up-converter for the plurality of encoded data and communication subcarriers; and
a channel combination unit configured to combine the post-processed data and communication subcarriers into a combined output signal capable of conversion to an analog optical signal for output from the coherent transmitter.

18. The DSP of claim 17, further comprising a burst preamble generator logically disposed between the high speed data subprocessor and the respective channel encoders, the burst preamble generator configured to construct a preamble for the payload of a respective data subcarrier, the preamble including one or more of a guard band, a receiver settling pattern, and a synchronization pattern.

19. A digital signal processor (DSP) for a coherent receiver, comprising:
a digital down converter configured to (a) receive digital subcarriers from the coherent receiver, (b) extract and separate, from the received digital subcarriers, a set of data subcarriers and a set of communication subcarriers, and (c) digitally down-convert each subcarrier from the set of data subcarriers and from the set of communication subcarriers into respective baseband signals;
a high-speed data subprocessor for individually processing each subcarrier from the set of down-converted data subcarriers;
a low-speed data subprocessor for individually processing each subcarrier from the set of down-converted communication subcarriers;
a first stage subprocessor for jointly processing the data subcarriers from the high-speed data subprocessor;
a first plurality of channel decoders configured to individually receive and decode each data subcarrier that is output from the first stage subprocessor; and
a second plurality of channel decoders configured to individually receive and decode each communication subcarrier that is output from the low-speed data subprocessor.

20. The DSP of claim 19, further comprising a burst detection and synchronization unit logically disposed between the high speed data subprocessor and the first stage subprocessor, the burst detection and synchronization unit configured to detect burst signal according to a preamble thereof, and then implement one or more of burst frame detection, chromatic dispersion (CD) compensation, burst clock recovery, and burst frame synchronization.
